(19) United States
(12) Patent Application Publication
(10) Pub. No.: US 2017/0365022 A1
(43) Pub. Date: Dec. 21, 2017

(54) LIQUID WORKFORCE PLATFORM

(71) Applicant: Accenture Global Solutions Limited, Dublin (IE)

(72) Inventors: Medb Corcoran, Dublin (IE); Diarmuid Cahalane, Dublin (IE); Colin Anil Puri, San Jose, CA (US)

(21) Appl. No.: 15/185,838

(22) Filed: Jun. 17, 2016

(51) Int. Cl. G06Q 50/20; G06Q 10/06

(52) U.S. Cl. CPC G06Q 50/2057; G06Q 10/067

(57) ABSTRACT

Methods, systems, and apparatus, including computer programs encoded on a computer storage medium, for managing skills of a workforce. The methods, systems, and apparatus include actions of obtaining data from internal sources that describes internal roles and skills corresponding to each of the internal roles, obtaining data from external sources that describes external roles and skills corresponding to each of the external roles, and generating a skill relationship model that represents relationships between the internal roles, external roles, and the skills. Further includes action include, for each of the skills, determining whether a difference between a degree of relationship between the skill and an external role and between the skill and an internal role matching the external role satisfies a relationship threshold, determining whether internal future supply for the skill satisfies internal future demand for the skill, and determining whether to train current employees in the skill.

### BACKGROUND

Information regarding skills of workers may be stored by various platforms. For example, a business-oriented social networking platform may describe skills that people possess.

### SUMMARY

In general, an aspect of the subject matter described in this specification may involve a system for managing skills of a workforce. In managing a skill in a workforce, the system may obtain data about the skill from both a variety of sources both within a company and outside the company. The system may normalize the obtained data to identify skills used within the company and skills used outside the company. The system may determine supply, demand, and costs for the identified skills based on the normalized data. For skills where the system determines that future supply of the skill within the company will be insufficient to meet future demand of the skill within the company, the system may determine whether to hire people with the skill on a full-time basis, hire people with the skill on a freelance basis, or train current employees in the skill. The system may then generate an exemplar electronic document providing indications of the determinations whether to hire people with the skill on a full-time basis, hire people with the skill on a freelance basis, or train current employees in the skill.

In some aspects, the subject matter described in this specification may be embodied in methods that may include the actions of obtaining data from internal sources that describes internal roles and skills corresponding to each of the internal roles, obtaining data from external sources that describes external roles and skills corresponding to each of the external roles, and generating a skill relationship model that represents relationships between the internal roles, external roles, and the skills. Further actions may include, for each of the skills, determining whether a difference between a degree of relationship, indicated by the skill relationship model, between the skill and an external role, and the degree of relationship, indicated by the skill relationship model, between the skill and an internal role matching the external role, satisfies a relationship threshold, in response to determining that the difference between the degree of relationship between the skill and the external role and the degree of relationship between the skill and the internal role matching the external role satisfies the relationship threshold, determining whether internal future supply for the skill satisfies internal future demand for the skill, in response to determining that the internal future supply for the skill does not satisfy the internal future demand for the skill, determining whether to train current employees in the skill, and in response to determining to train current employees in the skill, providing the current employees resources for training in the skill.

Other versions include corresponding systems, apparatus, and computer programs, configured to perform the actions of the methods, encoded on computer storage devices.

These and other versions may each optionally include one or more of the following features. For instance, in some implementations generating a skill relationship model that represents relationships between the internal roles, external roles, and the skills includes generating a knowledge graph where nodes of the graphs represent internal roles, external roles, and the skills, and edges between the nodes represent relationships between the nodes. In some aspects, each of the edges between an internal role and a skill is assigned a weight that indicates a frequency that the skill appears in data that describes the internal role.

In certain aspects, determining whether a difference between a degree of relationship, indicated by the skill relationship model, between the skill and an external role and the degree of relationship, indicated by the skill relationship model, between the skill and an internal role matching the external role satisfies a relationship threshold, includes identifying an external role that matches an internal role, determining that data from the external sources that describes the external role references the skill more than data from the internal sources that describes the internal role references the skill, and in response to determining that the data from the external sources that describes the external role references the skill more than the data from the internal sources that describes the internal role references the skill, determining that the difference between the degree of relationship between the skill and the external role and the degree of relationship between the skill and the internal role matching the external role satisfies the relationship threshold.

In some implementations, determining that data from the external sources that describes the external role references the skill more than data from the internal sources that describes the internal role references the skill, includes determining that the data from the external sources that describes the external role references the skill and the data from the internal sources that describes the internal role does not reference the skill. In certain aspects, determining that data from the external sources that describes the external role references the skill more than data from the internal sources that describes the internal role references the skill, includes determining that the data from the external sources that describes the external role references the skill more than the data from the internal sources that describes the internal role references the skill by more than a predetermined amount.

In some aspects, determining whether internal future supply for the skill satisfies internal future demand for the skill includes identifying all internal roles that the skill relationship model indicates as having a direct relationship to the skill, obtaining an estimated headcount for each of the internal roles identified as having the direct relationship to the skill, determining the internal future supply for the skill based on the estimated headcounts for each of the internal roles identified as having the direct relationship to the skill, and determining the internal future demand for the skill is equal to or less than the internal future supply.

In some implementations, determining whether to train current employees in the skill includes obtaining an internal cost for the skill, obtaining an external cost for the skill, and determining whether to train current employees in the skill based at least on the internal cost and the external cost. In certain aspects, obtaining an internal cost for the skill includes determining a classification of low, medium, or high for the internal cost for the skill based at least on the data from internal sources that describes internal roles and skills corresponding to each of the internal roles. In some aspects, obtaining an internal cost for the skill includes predicting the internal cost for the skill based at least on the data from internal sources that describes internal roles and skills corresponding to each of the internal roles. In some implementations, determining whether to train current employees in the skill based at least on the internal cost and the external cost includes determining a classification of hire full-time, hire freelance, or train current employees for the skill based at least on the internal cost and the external cost.

In certain aspects, providing the current employees resources for training in the skill includes identifying current employees to train in the skill, identifying training to provide the identified current employees, and providing a notification for the identified current employees to receive the training. In some aspects, the internal roles include roles that are used within a company. In certain aspects, the external roles include roles that are used by one or more other companies. In some implementations, the external source includes a business-oriented social network operated by a third party.

In certain aspects, obtaining data from external sources that describes external roles and skills corresponding to each of the external roles includes obtaining data from the external sources that describes one or more of movement of people or skills, where generating a skill relationship model that represents relationships between the internal roles, external roles, and the skills is based at least on the data from the external sources that describes one or more of movement of people or skills. In some aspects, obtaining data from internal sources that describes internal roles and skills corresponding to each of the internal roles includes obtaining data from internal sources on future predicted workloads or types of work projects, where generating a skill relationship model that represents relationships between the internal roles, external roles, and the skills is based at least on the data from internal sources on future predicted workloads or types of work projects.

In some implementations, actions include comparing the difference with a subsequent difference between the degree of relationship between the skill and the external role and the degree of relationship between the skill and the internal role, where the subsequent difference is determined based on data obtained subsequently to generating the skill relationship model and updating the skill relationship model based on the comparison between the difference and the subsequent difference.

One technical advantage may be that the system may utilize data in many different formats. For example, the system may ingest data from job offering postings found on the Internet or from profile pages of people in a business-oriented social networking platform. Another advantage may be that the system may reduce computational processing needed for workforce management. For example, the system may determine that internal future demand is satisfied by internal future supply and, in response, not further determine whether to train or instead hire for the skill. In another example, the system may determine that a skill used within the company is not used outside the company and, in response, not further determine whether future internal demand is satisfied by future internal supply.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a block diagram of an example system that can execute implementations of the present disclosure.

FIG. 2 is an example skill relationship model representing skills, roles, and relationships between the skills and roles.

FIG. 3 is a flowchart of an example process that can execute implementations of the present disclosure.

FIG. 4 is an example classification table for managing skills of a workforce.

FIG. 5 illustrates a schematic diagram of an exemplary generic computer system.

Like reference symbols in the various drawings indicate like elements.

### DETAILED DESCRIPTION

Implementations of the present disclosure are generally directed to a platform for managing a skill in a workforce, data about the skill is obtained from both a variety of sources both within an entity and outside of the entity. In some examples, the platform may normalize the obtained data to identify skills used within the entity and skills used outside of the entity. More particularly, implementations of the present disclosure are directed to obtaining data from internal sources that describes internal roles and skills corresponding to each of the internal roles, obtaining data from external sources that describes external roles and skills corresponding to each of the external roles, and providing a skill relationship model that represents relationships between the internal roles, external roles, and the skills. In some examples, for each of the skills, it is determined whether a difference between a degree of relationship between the skill and an external role, and a degree of relationship between the skill and an internal role matching the external role satisfies a relationship threshold. In some implementations, in response to determining that the difference between the degree of relationship between the skill and the external role and the degree of relationship between the skill and the internal role matching the external role satisfies the relationship threshold, it is determined whether an internal future supply for the skill satisfies internal future demand for the skill. In some examples, in response to determining that the internal future supply for the skill does not satisfy the internal future demand for the skill, it is determined whether to train current employees in the skill, and in response to determining to train current employees in the skill, the current employees are provided with resources for training in the skill.

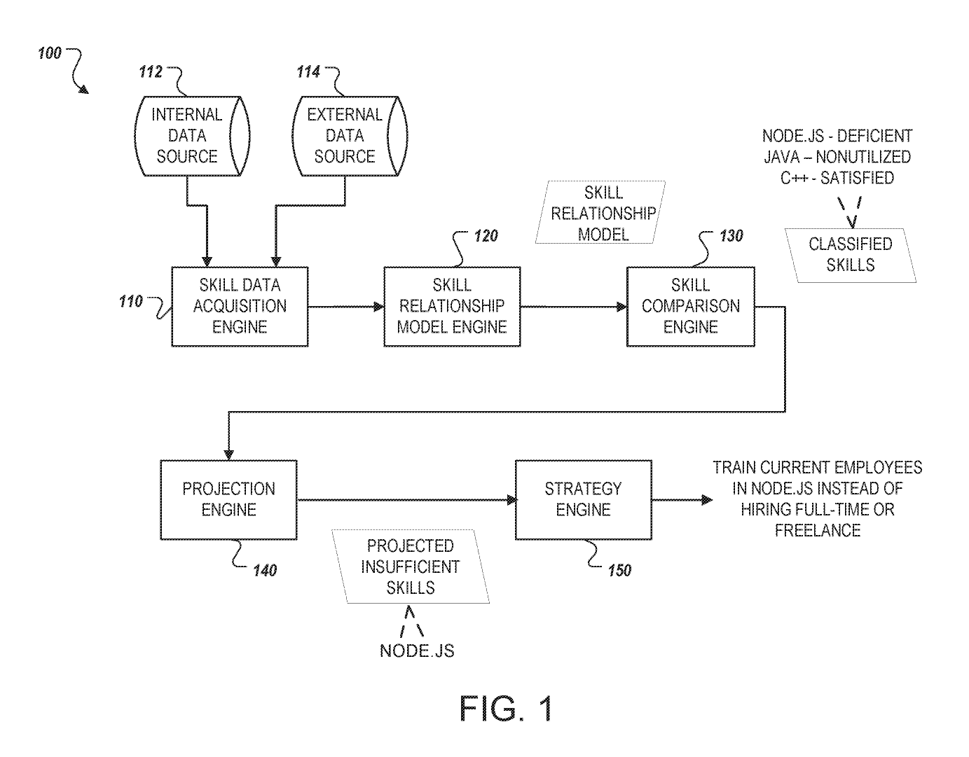

FIG. 1 is a block diagram of an example system 100 that can execute implementations of the present disclosure. Briefly, and as described in further detail below, the system 100 may include a skill data acquisition engine 110, a skill relationship model engine 120, a skill comparison engine 130, a projection engine 140, and a strategy engine 150.

The skill data acquisition engine 110 may obtain data that describes internal roles, external roles, and skills corresponding to the roles and normalize the data. For example, the acquisition engine 110 may obtain a project planning document from an internal company server that describes a role of “Front End Developer” should be filled by someone with skills in “node.JS” and “C++,” obtain a job posting from a website of another company for a role of “Front End Developer” that lists required skills of “node.JS,” “C++,” and “Java,” and generate a normalized set of data that indicates that an internal role of “Front End Developer” is associated with the skills “node.JS” and “C++” and that the external role of “Front End Developer” for the other company is associated with the skills “node.JS,” “C++,” and “Java.”

A role may refer to a job position and a skill may refer to an ability. Internal may refer to within a company and external may refer to outside of a company. For example, a role within the company may be referred to as an internal role and a role outside of the company may be referred to as an external role.

The acquisition engine 110 may obtain the data that describes internal roles and skills, also referred to as internal data, from one or more internal data sources 112. Internal data sources 112 may include one or more internal databases that store one or more of resumes or curriculum vitae of current employees, human resource descriptions of internal roles and skills associated with those roles, internal training documents that describe roles and skills to be trained for those roles, project management documentation describing roles and skills used by those roles, or other data sources within a company.

The acquisition engine 110 may obtain the data that describes external roles and skills, also referred to as external data, from one or more external data sources 114. The external data sources 114 may include one or more external servers that store one or more of a business-oriented social networking platform that includes profile pages that describe roles and skills possessed by people, job boards that describe roles and skills desired or required for those roles, external training documents that describe roles and skills to be trained for those roles, or other data sources outside of the company.

The acquisition engine 110 may perform an Extract, Transform and, Load (ETL) process on the obtained internal data and external data to normalize the data. For example, the acquisition engine 110 may perform ETL on resumes of current employees to extract out a current role held by the employee within the company and skills possessed by the employee, generate a normalized data set that indicates each of those roles identified in the resumes are associated with each of the corresponding skills, and provide the normalized data set to the skill relationship model engine 120. The acquisition engine 110 may perform the ETL using Natural Language Processing. For example, the acquisition engine 110 may obtain a document and use Natural Language Processing to identify relationships between terms for roles and terms for skills within the document, and extract out those roles and skills from the document and corresponding relationships.

In some implementations, the acquisition engine 110 may automatically determine when to perform ETL. For example, the acquisition engine 110 may detect changes in the internal data or the external data, and in response to detecting a change, perform the ETL process to update the normalized data. The acquisition engine 110 may allow for data source management. For example, the acquisition engine 110 may provide a graphical user interface that provides selectable control elements that enable an administrator to select or de-select data sources to use as internal data sources or external data sources.

The skill relationship model engine 120 may obtain the normalized data from the skill data acquisition engine 110 and generate a skill relationship model from the normalized data. A skill relationship model may be a model that represents relationships between skills. For example, the model engine 120 may obtain a normalized set of data that indicates that the project planning document indicates that an internal role of “Front End Developer” is associated with the skills “node.JS” and “C++” and that the external role of “Front End Developer” for the other company is associated with the skills “node.JS,” “C++,” and “Java,” and generate a skill relationship model that indicate that “node.JS” and “C++” are skills that are typically possessed together within the company, “C++” and “Java” are typically not possessed together within the company, and that “C++” and “Java” are typically possessed together outside the company. In some implementations, the skill relationship model may be a knowledge graph.

A knowledge graph is a collection of data representing entities and relationships between entities. The data is logically described as a graph, in which each distinct entity is represented by a respective node and each relationship between a pair of entities is represented by an edge between the nodes. Each edge is associated with a relationship and the existence of the edge represents that the associated relationship exists between the nodes connected by the edge. For example, if a node A represents a person alpha, a node B represents a person beta, and an edge E is associated with the relationship “is the father of,” then having the edge E connect the nodes in the direction from node A to node B in the graph represents the fact that alpha is the father of beta.

A knowledge graph can be represented by any of a variety of convenient physical data structures. For example, a knowledge graph can be represented by triples that each represent two entities in order and a relationship from the first to the second entity; for example, [alpha, beta, is the father of], or [alpha, is the father of, beta], are alternative ways of representing the same fact. Each entity and each relationship can be and generally will be included in multiple triples.

Alternatively, each entity can be stored as a node once, as a record or an object, for example, and linked through a linked list data structure to all the relationships the entity has and all the other entities to which the entity is related. More specifically, a knowledge graph can be stored as an adjacency list in which the adjacency information includes relationship information.

It is generally advantageous to represent each distinct entity and each distinct relationship with a unique identifier.

The entities represented by a knowledge graph need not be tangible things or specific people. The entities can include particular people, places, things, artistic works, concepts, events, or other types of entities. Thus, a knowledge graph can include data defining relationships between people, e.g., co-stars in a movie; data defining relationships between people and things, e.g., a particular singer recorded a particular song; data defining relationships between places and things, e.g., a particular type of wine comes from a particular geographic location; data defining relationships between people and places, e.g., a particular person was born in a particular city; and other kinds of relationships between entities.

In some implementations, each node has a type based on the kind of entity the node represents; and the types can each have a schema specifying the kinds of data that can be maintained about entities represented by nodes of the type and how the data should be stored. So, for example, a node of a type for representing a person could have a schema defining fields for information such as birth date, birth place, and so on. Such information can be represented by fields in a type-specific data structure, or by triples that look like node-relationship-node triples, e.g., [person identifier, was born on, date], or in any other convenient predefined way. Alternatively, some or all of the information specified by a type schema can be represented by links to nodes in the knowledge graph; for example, [one person identifier, child of, another person identifier], where the other person identifier is a node in the graph.

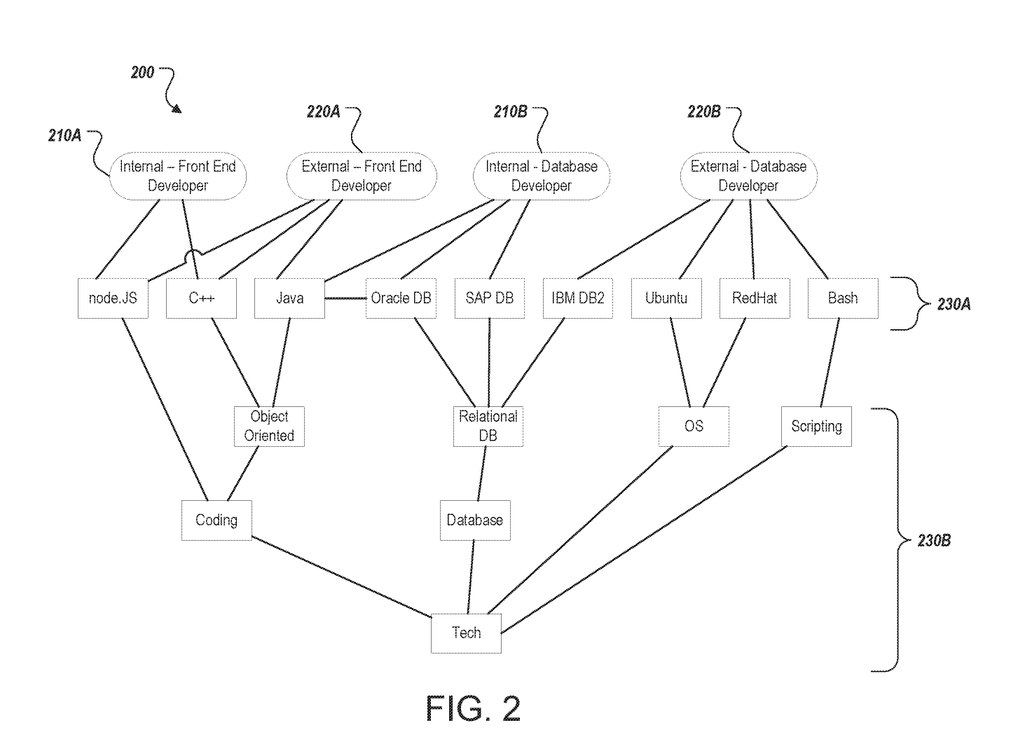

FIG. 2 is an example skill relationship model 200 representing skills, roles, and relationships between the skills and roles. The skill relationship model 200 is in the form of a knowledge graph where nodes represent roles or skills and edges represent relationships between the nodes. For example, the node for “Internal-Front End Developer” has edges with nodes for the skills “node.JS” and “C++,” respectively, and the node for “External-Front End Developer” has edges with nodes for the skills “node.JS,” “C++,” and “Java,” respectively.

Nodes may include the properties of class, historical demand level, forecast demand level, forecasted supply level, and forecasted cost of labor. Class may include options of “internal permanent,” “internal temporary contract,” “external permanent,” and “external temporary contractor.” “Permanent” may refer to a full-time and “temporary contract” may refer to freelance. Historical demand level, forecast demand level, forecasted supply level may have values that indicate a discrete category. For example, categories may include, less than ten employees, ten through one hundred employees, one hundred through five hundred employees, more than five hundred employees, or other levels. Forecasted cost of labor may have values that indicate a discrete category. For example, categories may include, low, medium, and high, or other levels.

The role nodes may share edges with skill nodes and the skill nodes may share edges with role nodes or other skill nodes. The edges between pairs of role node and skill node may be weighted based on a frequency that the skill appears in data describing the role node. For example, a skill that is frequently described in data associated with a role may have a high weight and a skill that is infrequently described in data associated with a role may have a low weight. In some implementations, the weight of an edge may represent a strength of association of the nodes connected by the edge. For example, two skills may be strongly associated so have a high weight or weakly associated so have a low weight. These weights may be numerical variables associated with their respective edges. Each node may include a field that describes all the nodes that the node shares an edge and the associated weight for the edge to that node.

Returning to FIG. 1, the model engine 120 may generate the skill relationship model from the normalized data based on machine learning. For example, the model engine 120 may use supervised learning to train to recognize associations between roles and skills within the normalized data. In some implementations, the model engine 120 may be trained in fuzzy matching of terms so that small differences in a description of a role or skill results are recognized as the same role or skill, and trained to recognize terms that indicate relationships between skills or between a role and skill. For example, the model engine 120 may provide a graphical user interface that an administrator may use to manually curate relationships identified by the model engine 120, or manually identify that two terms should match, so that the model engine 120 may learn from the manual curation. In some implementations, the model engine 120 may be trained in the classification of a class, historical demand level, forecasted demand level, forecasted supply level, and forecasted cost of labor. For example, the model engine 120 may provide a graphical user interface that an administrator may use to initially indicate how particular sets of normalized data sets should be classified for the model engine 120 to learn to make similar classifications for future data sets.

In some implementations, the model engine 120 may generate a cost function for skills. For example, a cost function may indicate that a skill “Java” is associated with a cost of $50,000 per head. The model engine 120 may generate a cost function based on identifying all roles indicated by the skill relationship model as associated with a particular skill, identify the role with the with the lowest forecasted cost of labor, and generate the cost function used the forecasted cost of labor for the identified role.

In some implementations, the model engine 120 may generate the skill relationship model based on data from the external sources that describes one or more of movement of people or skills. For example, the model engine 120 may determine external data describes that people are moving to a location that makes them eligible for hiring by the company and, in response, increase a future supply level for skills corresponding to those people. In another example, the model engine 120 may determine external data describes that a particular skill is increasing in availability based on people learning a skill and, in response, increase a future supply level for the skill. In some implementations, the model engine 120 may generate the skill relationship model based at least on the data from internal sources on future predicted workloads or types of work projects. For example, the model engine 120 may determine that internal data describes a future predicted workload and, in response, adjust the future demand level for a skill corresponding to the workload. In another example, the model engine 120 may determine that internal data describes future types of work projects and, in response, adjust the future demand level for a skills needed by the future types of work projects.

The skill comparison engine 130 may obtain the skill relationship model and generate a set of classified skills based on the skill relationship model. The set classified skills may indicate skills for which future supply within the company may not satisfy future demand within the company. For example, the skill comparison engine 130 may obtain a skill relationship model that indicates that skill in “Java” is not associated with the internal role of “Front End Developer” but is associated with the external role of “Front End Developer,” e.g., when the company is lagging behind the market when the market is moving towards using “Java” for front end development, and, in response, generate a set of classified skills that indicates that the skill “Java” is non-utilized.

The skill comparison engine 130 may generate the set of classified skills based on analyzing the skill relationship model. For example, skills may be classified as satisfied, non-utilized, or deficient. The comparison engine 130 may generate the set of classified skills by determining whether a difference between a degree of relationship, indicated by the skill relationship model, between the skill and an external role and the degree of relationship, indicated by the skill relationship model, between the skill and an internal role matching the external role satisfies a relationship threshold. As further described below, where the relationship threshold is satisfied the skill may be classified as non-utilized or deficient and where the relationship threshold is not satisfied the skill may be classified as satisfied.

For example, the comparison engine 130 may determine that the weight between the skill “C++” and the internal role “Front End Developer” is equal to the weight between the skill “C++” and the external role “Front End Developer,” and in response, determine that the skill “C++” for the internal role “Front End Developer” is sufficient and relationship threshold is not satisfied.

In another example, the comparison engine 130 may determine that the weight between the skill “C++” and the internal role “Front End Developer” is greater than the weight between the skill “C++” and the external role “Front End Developer,” and in response, determine that the skill “C++” for the internal role “Front End Developer” is overly sufficient and relationship threshold is not satisfied.

In yet another example, the comparison engine 130 may determine that weight between the skill “C++” and the internal role “Front End Developer” is less than the weight between the skill “C++” and the external role “Front End Developer” by a predetermined amount, e.g., 0.5, and in response, determine that the skill “C++” for the internal role “Front End Developer” is deficient and relationship threshold is satisfied.

In some implementations, the comparison engine 130 may compare weights between the skill and other nodes up to predetermined number of hops, e.g., one, two or more hops. For example, the comparison engine 130 may sum the weights of edges from the skill “C++” to the internal role “Front End Developer” and from the internal role “Front End Developer” to “node.JS” and compare that to the sum of the weights of edges from the skill “C++” to the external role “Front End Developer” and from the external role “Front End Developer” to “node.JS” and to “Java.”

In still another example, the comparison engine 130 may determine that “C++” is not associated with the internal role “Front End Developer” and is associated with the external role “Front End Developer,” and in response, determine that the skill “C++” for the internal role “Front End Developer” is not utilized and relationship threshold is satisfied.

In comparing weights, the comparison engine 130 may identify matching internal roles and external roles and compare weights of corresponding edges between the matching roles and skills. For example, the comparison engine 130 may identify that an internal role “Front End Developer” matches an external role “Front End Developer.” In another example, the comparison engine 130 may identify that an internal role “Market Research Analyst” matches an external role “Market Researcher.” The comparison engine 130 may identify matching internal and external roles using one or more of term matching, predetermined rules, fuzzy matching, or supervised learning.

In a detailed example, the comparison engine 130 may semantically match (or rule based match) each internal role (Int_{y}) and its skillset (s_Int_{y}) to an external role (Ext_{y}) and its skillset (s_Ext_{y}) sets. For all skills s, such that s ∈ s_Int_{y} ∪ s_Ext_{y} up to a specified indirection or hop distance specified by Dₛ, calculate the difference in edges (via weights) for every skill (e.g. skillrelationlevelₛ_{_}_{Int}_{_{y}}_{Ext}_{_{y}}=sₛ_{_}_{Int}_{_{y}}−Sₛ_{_}_{Ext}_{_{y}}) and store as apart of the SkillRelationLevel set. If skillrelationlevel_s_{Int}_{_{y}}_{Ext}_{_{y}}=0 then there is an exact match on the degree of the skill both internally and externally and the skill may be considered satisfied. If skillrelationlevel_s_{Int}_{_{y}}_{Ext}_{_{y}}<0 then the internal skill is deficient with respect to an external demand and s_{Int}_{_{y}} ∈ DeficientSkills ∀ s|skillrelationlevel_s_{Int}_{_{y}}_{Ext}_{_{y}}<skillrelationlevelthreshold. If skillrelationlevel_s_{Int}_{_{y}}_{Ext}_{_{y}}>0 then the internal skills exceeds the expectations or quality with respect to external demand and the skill may be considered satisfied. Non-utilized skills, skill opportunity, or skill gap areas may be skills that are demanded by the external role by not used by the internal role s_{Ext}_{_{y}} ∈ NonutilizedSkillGap∀s|s_{Ext}_{_{y}} ∈ s_Ext_{y} and s_{Ext}_{_{y}} ∉ s_Int_{y}. Unique skills may be skills that are utilized internally for a role by not externally for the same role such that s_{Int}_{_{y}} ∈ UniqueSkills ∀ s|s|s_{Int}_{_{y}} ∈ s_Int_{y} and s_{Int}_{_{y}} ∉ s_Ext_{y} and the skill may be considered satisfied.

The projection engine 140 may obtain the classified skills from the skill comparison engine and generate a set of projected insufficient skills. For example, the project engine 140 may obtain a classification of “node.JS” as deficient, “Java” as non-utilized, and “C++” as satisfied, and generate a set of projected insufficient skills of just “node.JS.” The set of projected insufficient skills may indicate a set of skills for which future internal supply within a company may be insufficient to meet future internal demand within the company.

The projection engine 140 may generate the set of projected insufficient skills based on, for each of the skills classified as deficient or non-utilized, determining whether the forecasted internal demand for the skill outweighs the forecasted internal supply for the skill and including those skills that have forecasted internal demand outweighing the forecasted internal supply in the set. The projection engine 140 may skip this determination for skills that are not classified as deficient or non-utilized. For example, the projection engine 140 may obtain a classification of “node.JS” as deficient, “Java” as non-utilized, and “C++” as satisfied, and determine whether the forecasted internal demand for “node.JS” and “Java” outweigh the forecasted internal supply for those skills and not make that determination for “C++.”

In making the determination, the projection engine 140 may sum the forecasted internal demand for the skill for all internal roles and sum the forecasted internal supply for the skill for all internal roles. For example, the skill “node.JS” may be associated with both the internal role “Front End Developer” and the internal role “Mobile Web Application Developer,” and associated with no other internal roles, and the projection engine 140 may sum a forecasted internal demand level of one hundred to five hundred heads for “Front End Developer” and a forecasted internal demand level of over five hundred heads for “Mobile Web Application Developer,” sum a forecasted internal supply level of ten to one hundred heads for “Front End Developer” and a forecasted internal supply level of over one hundred to five hundred heads for “Mobile Web Application Developer, determine that the summed forecasted internal demand is greater than the summed forecasted internal supply, and in response, determine that the forecasted internal demand for the skill outweighs the forecasted internal supply for the skill. As described above, the forecasted internal demand and forecasted internal supply may be obtained from the knowledge graph 200.

The strategy engine 150 may obtain the set of projected insufficient skills and generate a classification table that indicates a recommended strategy for the skill. A recommended strategy may include one of train current employees in the skill, hire full-time employees with the skill, hire freelance employees with the skill, or some other recommendation.

The strategy engine 150 may make the recommendation for a skill based on comparing the forecasted internal cost indicated by the skill relationship model with the forecasted external cost. For example, the strategy engine 150 may determine that the forecasted internal cost to train current employees in “node.JS” is “Medium” and that the forecasted external cost to hire new employees in “node.JS” is “High,” and in response, determine to train current employees. In another example, the strategy engine 150 may determine that the forecasted internal cost to train current employees in “node.JS” is “High” and that the forecasted external cost to hire new employees in “node.JS” is “Medium,” and in response, determine to hire new employees with the skill “node.JS” on a freelance basis. In yet another example, the strategy engine 150 may determine that the forecasted internal cost to train current employees in “node.JS” is “High” and that the forecasted external cost to hire new employees in “node.JS” is “Low,” and in response, determine to hire new employees with the skill “node.JS” on a full-time basis. The forecasted internal and external costs can be the cost functions determined by the model engine 120.

In making the determination based on comparing the forecasted internal cost indicated by the skill relationship model with the forecasted external cost, the strategy engine 150 may use adaptive learning. For example, the strategy engine 150 may train a set of neural nets to map inputs of one or more of costs, internal and external demand levels, internal and external supply levels to a recommendation. In some implementations, the strategy engine 150 may feed back results of a strategy to improve future recommendations. For example, the strategy engine 150 may show that training in a particular skill actually had a greater cost than expected and update the internal cost associated with the skill.

The strategy engine 150 may provide the recommendation to a user. For example, the strategy engine 150 may include a classification table in a graphical user interface that is displayed to an administrator. In some implementations, the strategy engine 150 may identify employees to receiving training. For example, in response to determining a recommendation to train, the strategy engine 150 may identify employees, indicated in the internal data, that already possess skills indicated as related by the skill relationship model and identify those employees to the administrator in a graphical user interface. In a particular example, the strategy engine 150 may identify that “John Doe” is a “Front End Developer” and does not possess the skill “Java” but according to the knowledge graph 200 that a corresponding external “Front End Developer” does possess the skill “Java,” and in response, identify “John Doe” for training in “Java.” In another particular example, the strategy engine 150 may identify that the skill “Java” is related to the skill “C++” according to the knowledge graph 200 as they are both related to the node for “Object Oriented,” and in response, identify employees with the skill “C++” and without the skill “Java” for training in “Java.”

In some implementations, the strategy engine 150 may provide the recommendation to the user by generating an exemplar electronic document. In some examples, an exemplar electronic document can be provided as a template that includes fields for historical and future internal demand and external demand, future internal supply and external supply, future internal cost and external cost, and a recommended strategy, and values for each of the fields. The values may be populated based on the classifications and recommendation determined by the strategy engine 150.

In some implementations, the strategy engine 150 may identify training material for training in the skill. For example, in response to determining a recommendation to train, the strategy engine 150 may identify training material associated with the skill and identify those training materials to the administrator in a graphical user interface. In some implementations, the strategy engine 150 may identify people to hire. For example, in response to determining a recommendation to hire, the strategy engine 150 may identify people, indicated in the external data, that possess the skills and identify those people to the administrator in a graphical user interface.

Different configurations of the system 100 may be used where functionality of the skill data acquisition engine 110, the skill relationship model engine 120, the skill comparison engine 130, the projection engine 140, and the strategy engine 150 may be combined, further separated, distributed, or interchanged. For example, the functionality of the projection engine 140 and the strategy engine 150 may be combined in a single engine.

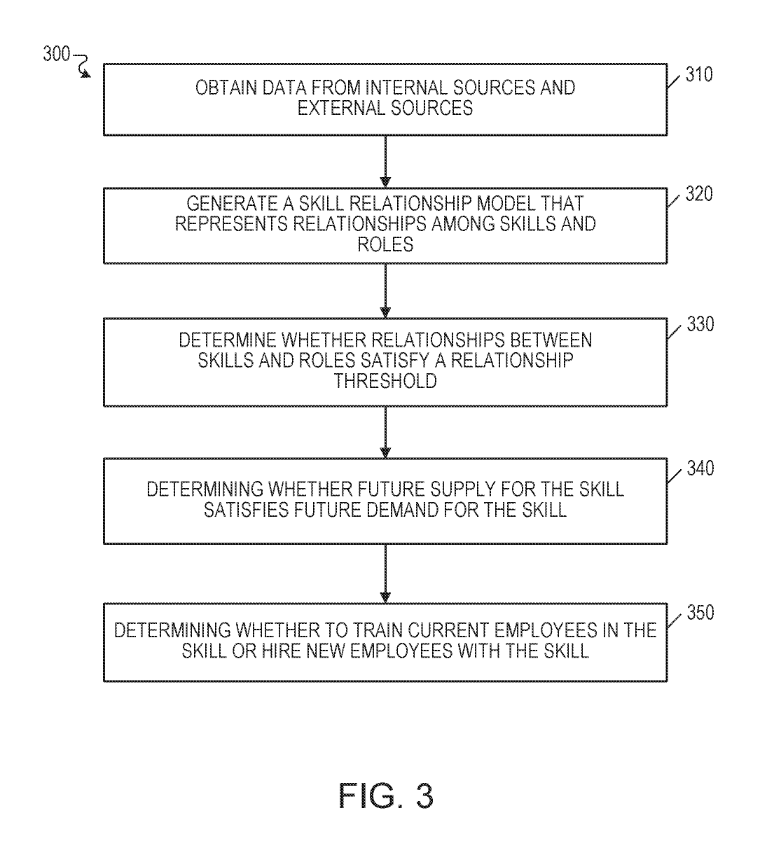

FIG. 3 is a flowchart of an example process 300 that can execute implementations of the present disclosure. The following describes the process 300 as being performed by components of the systems 100 that are described with reference to FIG. 1. However, the process 300 may be performed by other systems or system configurations.

The process 300 may include obtaining data from internal sources and external sources (310). For example, the skill data acquisition engine 110 may obtain intra-company human resources documents from a company human resource database, intra-company project role descriptions from a company project management database, webpages from web servers of other companies, profile pages from a business-oriented social networking platform, and other data from other sources.

The process 300 may include generating a skill relationship model that represents relationships among skills and roles (320). For example, the skill relationship model engine 120 may obtain the data and generate a skill relationship model. The skill relationship model may be a knowledge graph where nodes represent roles and skills and edges represent relationships between the roles and skills.

The process 300 may include determining whether relationships between the skills and roles satisfy a relationship threshold (330). For example, the process 300 may determine that the relationships for the skill “data analysis” satisfy a relationship threshold.

In making the determination, the skill comparison engine 130 may identify an external role that matches an internal role, determine that data from the external sources that describes the external role references the skill more than data from the internal sources that describes the internal role references the skill, and in response to determining that the data from the external sources that describes the external role references the skill more than the data from the internal sources that describes the internal role references the skill, determine that the difference between the degree of relationship between the skill and the external role and the degree of relationship between the skill and the internal role matching the external role satisfies the relationship threshold. For example, the comparison engine 130 may determine that the internal role “market research analyst” matches the external role “market researcher,” determine that internal data describing the internal role “market research analyst” references “data analysis” less than half as frequently as data describing the external role “market researcher” references “data analysis,” and, in response, determine that the difference between the degree of relationship between “data analysis” and the external role and the degree of relationship between “data analysis” and the internal role matching the external role satisfies the relationship threshold.

In another example, the skill comparison engine 130 may determine that the data from the external sources that describes the external role references the skill and the data from the internal sources that describes the internal role does not reference the skill, and in response, determine that the relationship threshold is satisfied. For example, the skill comparison engine 130 may determine that external data regarding “market researcher” references the skill “communication” and internal data regarding “market research analyst” does not reference the skill “communication,” and in response, determine that the relationship threshold is satisfied for the skill “communication.”

The process 300 may include determining whether future supply for the skill satisfies future demand for the skill (340). For example, the projection engine 140 may identify roles that are directly associated with the skill “data analysis,” sum the internal future supply for each of the roles, sum the internal future demand for each of the roles, and determine whether sum of the internal future supply for “data analysis” is equal to or greater than the sum of the internal future demand for “data analysis.”

The process 300 may include determining whether to train current employees in the skill or hire new employees with the skill (350). For example, the strategy engine 150 may obtain the internal future cost of “High” for “data analysis” and external future cost of “Medium” for “data analysis” from the skill model and provide the costs to a trained neural network to receive an output of a recommendation to hire freelance.

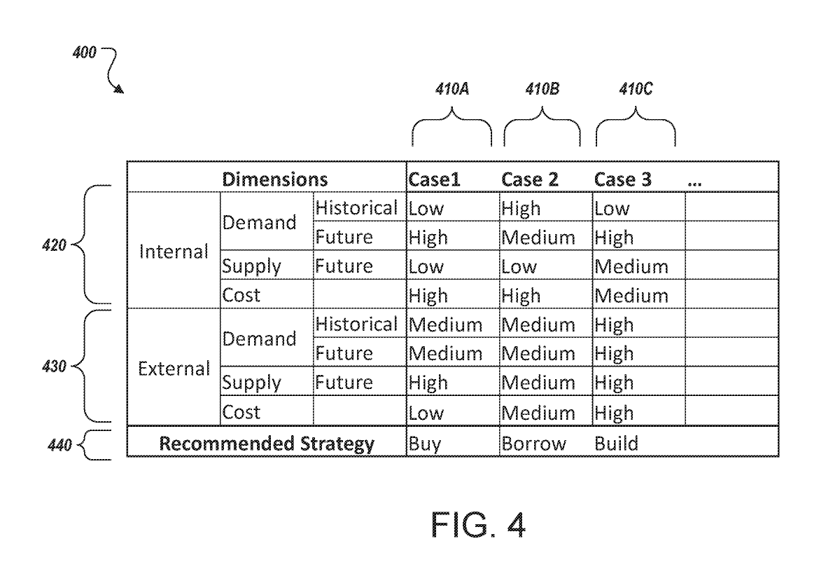

FIG. 4 is an example classification table 400 for managing skills of a workforce. The table 400 includes case columns 410A, 410B, and 410C that each refer to a particular skill, internal rows 420 that refer to internal demand (historical and future), internal future supply, and internal cost, external rows 430 that refer to external demand (historical and future), external future supply, and external cost, and a recommended strategy 440 for each case column. For example, the classification table 400 shows that skill “Case 1” has an internal demand (historical) of “Low,” internal demand (future) of “High,” internal future supply of “Low,” internal cost of “High,” external demand (historical) of “Medium,” external demand (future) of “Medium,” external supply of “High,” external cost of “Low,” and a recommended strategy of “Buy.”

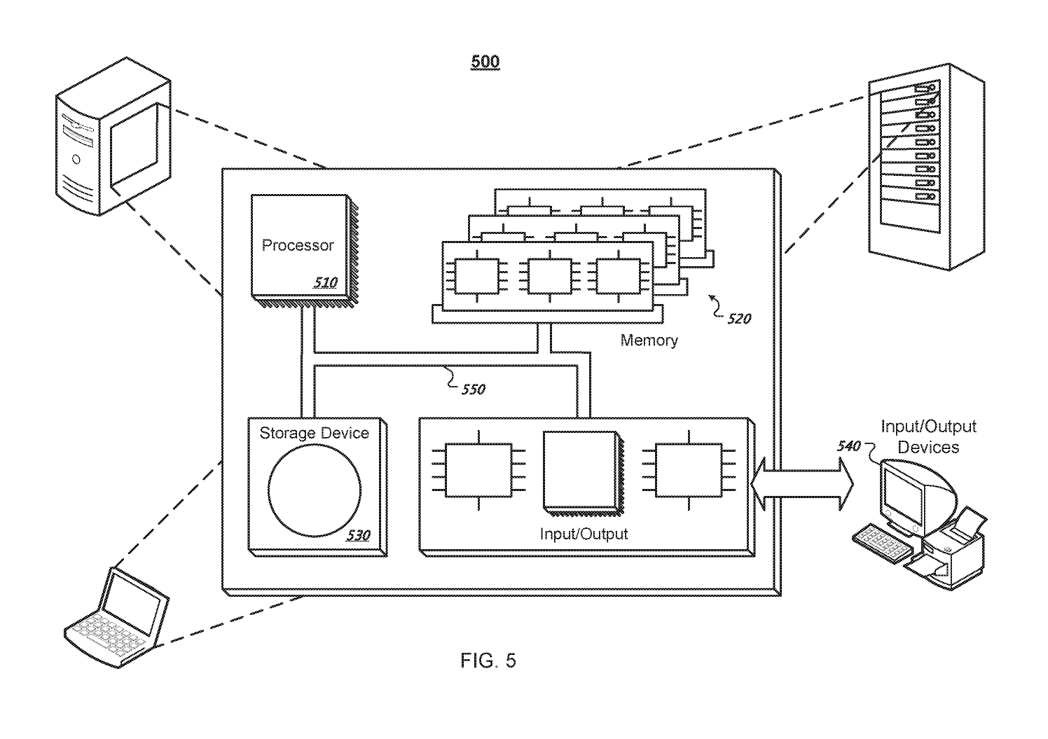

FIG. 5 illustrates a schematic diagram of an exemplary generic computer system. The system 500 can be used for the operations described in association with the processes 300 according to some implementations. The system 500 may be included in the system 100.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

1. A computer-implemented method comprising:
obtaining data from internal sources that describes internal roles and skills corresponding to each of the internal roles;
obtaining data from external sources that describes external roles and skills corresponding to each of the external roles;
generating a skill relationship model that represents relationships between the internal roles, external roles, and the skills;
for each of the skills:
determining whether a difference between a degree of relationship, indicated by the skill relationship model, between the skill and an external role, and the degree of relationship, indicated by the skill relationship model, between the skill and an internal role matching the external role, satisfies a relationship threshold;
in response to determining that the difference between the degree of relationship between the skill and the external role and the degree of relationship between the skill and the internal role matching the external role satisfies the relationship threshold, determining whether internal future supply for the skill satisfies internal future demand for the skill;
in response to determining that the internal future supply for the skill does not satisfy the internal future demand for the skill, determining whether to train current employees in the skill; and
in response to determining to train current employees in the skill, providing the current employees resources for training in the skill.

2. The method of claim 1, wherein generating a skill relationship model that represents relationships between the internal roles, external roles, and the skills comprises:
generating a knowledge graph where nodes of the graphs represent internal roles, external roles, and the skills, and edges between the nodes represent relationships between the nodes.

3. The method of claim 2, wherein each of the edges between an internal role and a skill is assigned a weight that indicates a frequency that the skill appears in data that describes the internal role.

4. The method of claim 1, wherein determining whether a difference between a degree of relationship, indicated by the skill relationship model, between the skill and an external role and the degree of relationship, indicated by the skill relationship model, between the skill and an internal role matching the external role satisfies a relationship threshold, comprises:
identifying an external role that matches an internal role;
determining that data from the external sources that describes the external role references the skill more than data from the internal sources that describes the internal role references the skill; and
in response to determining that the data from the external sources that describes the external role references the skill more than the data from the internal sources that describes the internal role references the skill, determining that the difference between the degree of relationship between the skill and the external role and the degree of relationship between the skill and the internal role matching the external role satisfies the relationship threshold.

5. The method of claim 1, wherein determining that data from the external sources that describes the external role references the skill more than data from the internal sources that describes the internal role references the skill, comprises:
determining that the data from the external sources that describes the external role references the skill and the data from the internal sources that describes the internal role does not reference the skill.

6. The method of claim 1, wherein determining that data from the external sources that describes the external role references the skill more than data from the internal sources that describes the internal role references the skill, comprises:
determining that the data from the external sources that describes the external role references the skill more than the data from the internal sources that describes the internal role references the skill by more than a predetermined amount.

7. The method of claim 1, wherein determining whether internal future supply for the skill satisfies internal future demand for the skill comprises:
identifying all internal roles that the skill relationship model indicates as having a direct relationship to the skill;
obtaining an estimated headcount for each of the internal roles identified as having the direct relationship to the skill;
determining the internal future supply for the skill based on the estimated headcounts for each of the internal roles identified as having the direct relationship to the skill; and
determining the internal future demand for the skill is equal to or less than the internal future supply.

8. The method of claim 1, wherein determining whether to train current employees in the skill comprises:
obtaining an internal cost for the skill;
obtaining an external cost for the skill; and
determining whether to train current employees in the skill based at least on the internal cost and the external cost.

9. The method of claim 8, wherein obtaining an internal cost for the skill comprises:
determining a classification of low, medium, or high for the internal cost for the skill based at least on the data from internal sources that describes internal roles and skills corresponding to each of the internal roles.

10. The method of claim 8, wherein obtaining an internal cost for the skill comprises:
predicting the internal cost for the skill based at least on the data from internal sources that describes internal roles and skills corresponding to each of the internal roles.

11. The method of claim 8, wherein determining whether to train current employees in the skill based at least on the internal cost and the external cost comprises:
determining a classification of hire full-time, hire freelance, or train current employees for the skill based at least on the internal cost and the external cost.

12. The method of claim 1, wherein providing the current employees resources for training in the skill comprises:
identifying current employees to train in the skill;
identifying training to provide the identified current employees; and
providing a notification for the identified current employees to receive the training.

13. The method of claim 1, wherein the internal roles comprise roles that are used within a company.

14. The method of claim 1, wherein the external roles comprise roles that are used by one or more other companies.

15. The method of claim 1, wherein the external source comprises a business-oriented social network operated by a third party.

16. The method of claim 1, wherein obtaining data from external sources that describes external roles and skills corresponding to each of the external roles comprises obtaining data from the external sources that describes one or more of movement of people or skills,
wherein generating a skill relationship model that represents relationships between the internal roles, external roles, and the skills is based at least on the data from the external sources that describes one or more of movement of people or skills.

17. The method of claim 1, wherein obtaining data from internal sources that describes internal roles and skills corresponding to each of the internal roles comprises obtaining data from internal sources on future predicted workloads or types of work projects,
wherein generating a skill relationship model that represents relationships between the internal roles, external roles, and the skills is based at least on the data from internal sources on future predicted workloads or types of work projects.

18. The method of claim 1, comprising:
comparing the difference with a subsequent difference between the degree of relationship between the skill and the external role and the degree of relationship between the skill and the internal role, where the subsequent difference is determined based on data obtained subsequently to generating the skill relationship model; and
updating the skill relationship model based on the comparison between the difference and the subsequent difference.

19. A system comprising:
one or more computers and one or more storage devices storing instructions that are operable, when executed by the one or more computers, to cause the one or more computers to perform operations comprising:
obtaining data from internal sources that describes internal roles and skills corresponding to each of the internal roles;
obtaining data from external sources that describes external roles and skills corresponding to each of the external roles;
generating a skill relationship model that represents relationships between the internal roles, external roles, and the skills;
for each of the skills:
determining whether a difference between a degree of relationship, indicated by the skill relationship model, between the skill and an external role, and the degree of relationship, indicated by the skill relationship model, between the skill and an internal role matching the external role, satisfies a relationship threshold;
in response to determining that the difference between the degree of relationship between the skill and the external role and the degree of relationship between the skill and the internal role matching the external role satisfies the relationship threshold, determining whether internal future supply for the skill satisfies internal future demand for the skill;
in response to determining that the internal future supply for the skill does not satisfy the internal future demand for the skill, determining whether to train current employees in the skill; and
in response to determining to train current employees in the skill, providing the current employees resources for training in the skill.

20. A non-transitory computer-readable medium storing software comprising instructions executable by one or more computers which, upon such execution, cause the one or more computers to perform operations comprising:
obtaining data from internal sources that describes internal roles and skills corresponding to each of the internal roles;
obtaining data from external sources that describes external roles and skills corresponding to each of the external roles;
generating a skill relationship model that represents relationships between the internal roles, external roles, and the skills;
for each of the skills:
determining whether a difference between a degree of relationship, indicated by the skill relationship model, between the skill and an external role, and the degree of relationship, indicated by the skill relationship model, between the skill and an internal role matching the external role, satisfies a relationship threshold;
in response to determining that the difference between the degree of relationship between the skill and the external role and the degree of relationship between the skill and the internal role matching the external role satisfies the relationship threshold, determining whether internal future supply for the skill satisfies internal future demand for the skill;
in response to determining that the internal future supply for the skill does not satisfy the internal future demand for the skill, determining whether to train current employees in the skill; and
in response to determining to train current employees in the skill, providing the current employees resources for training in the skill.
